(19) United States
(12) Patent Application Publication
(10) Pub. No.: US 2015/0120947 A1
(43) Pub. Date: Apr. 30, 2015

(54) METHOD AND A PROXY-CALL SESSION CONTROL FUNCTION NODE FOR DEREGISTRATION OF A USER EQUIPMENT FROM AN INTERNET MULTIMEDIA SUBSYSTEM

(71) Applicants: Leon Guo, Shanghai (CN); Per Ferngren, Bromma (SE); Jan Holm, Gavle (SE)

(72) Inventors: Leon Guo, Shanghai (CN); Per Ferngren, Bromma (SE); Jan Holm, Gavle (SE)

(73) Assignee: Telefonaktiebolaget L M Ericsson (publ), Stockholm (SE)

(21) Appl. No.: 14/383,806

(22) PCT Filed: Mar. 12, 2012
(86) PCT No.: PCT/EP2012/054287

§ 371 Date: Sep. 8, 2014

(51) Int. Cl. H04L 29/08

(52) U.S. Cl. CPC H04L 67/143; H04L 67/142
USPC 709/228

(57) ABSTRACT

The present invention relates to a method for deregistration of a UE from an IMS, the deregistration being initiated from and performed by a P-CSCF node. The present invention also relates to a P-CSCF node comprising a processor and a memory storing a computer program, which when run in the processor, causes the P-CSCF node to perform the method. The method includes monitoring at least one parameter associated with UE behaviour in the IMS and triggering generation of a message in response to that the monitored parameter meets predefined criteria. The message is inserted in a SIP header message and sent to the S-CSCF node which forwards it to the HSS. The P-CSCF node then receives an acknowledgement from the S-CSCF node that the UE has been deregistered from the HSS and terminates the UE session with the IMS.

### TECHNICAL FIELD

Embodiments of the present invention presented herein generally relate to deregistration of a UE, User Equipment, from an IMS, Internet Protocol Multimedia Subsystem. More specifically, embodiments of the present invention relate to methods, P-CSCF nodes, Proxy-Call Session Control Function nodes, computer programs and computer program products for facilitating deregistration of UEs from the IMS.

### BACKGROUND

Today the use of IMS is growing fast. This is due to that the demand of multimedia services for UEs is increasing. Modern communication technology and modern computing technology has led to a new generation of UEs. Some UEs that are ubiquitous today have a small form factor and are used for execution of a wide range of applications. Examples of such apparatuses are portable electronic devices. Portable electronic devices include, but are not limited to, mobile telephones (sometimes also referred to as mobile phones, cell phones, cellular telephones, smart phones and the like), tablet computers and laptop computers. This development of UEs and especially smart phones allow users an easy access to such services wherever they are.

IMS is an architectural framework for delivering IP, Internet Protocol, multimedia services. It was originally designed by the wireless standard body 3^{rd} Generation Partnership Project (3GPP) as a part of a vision to evolve mobile networks. As is stated in the 3GPP TS 23.228 standard, the IMS comprises core network elements for provision of multimedia services. This includes the collection of signalling and bearer related network elements as defined in TS 23.002. The IMS enables PLMN, Public Land Mobile Network, operators to offer their subscribers multimedia services based on and built upon Internet applications, services and protocols.

According to the 3GPP TS 23.228 standard the P-CSCF node is the UEs first contact point within the IMS. The UE may obtain the P-CSCF IP addresses via the P-CSCF discovery mechanism as specified in the section 5.1.11 of the standard. Often there are at least two P-CSCF nodes provided for increasing the availability of IMS services for the UE. As a proxy SIP, Session Initiation Protocol, server the P-CSCF node will perform functions such as forwarding the SIP register request that is received from the UE to a core network entry point, i.e. an I-CSCF, Interrogating-Call Session Control Function, node which is determined by using the home domain name, as provided by the UE. Furthermore the P-CSCF node will also forward subsequent SIP messages received from the UE to a SIP server, for example a S-CSCF, Serving-Call Session Control Function, node whose identity/address the P-CSCF node has received as a result of the registration procedure. Depending on operator policies, the P-CSCF node may insert the access network type currently used by the UE into any SIP message, if the information is available from the access network. The P-CSCF node may furthermore forward SIP requests from the UE to the core network or responses from the core network to the UE. Another function of the P-CSCF node is the authentication of the UE in cooperation with the S-CSCF node and the HSS, Home Subscriber Server, and the assertion of the UE identity during the following signalling with the UE.

Thus, before a user can use the IMS services it first needs to register towards the IMS system. The initial registration procedure starts with the UE sending a SIP message towards the IMS containing the IMPU, IMS Public User Identity, and the IMPI, IMS Private User Identity. The P-CSCF node as the proxy registrar forwards the message towards the I-CSCF node and the I-CSCF node selects an appropriate S-CSCF node to serve the user. The selected S-CSCF node will then interact with the HSS to download the user subscription profile related to the user. The selected S-CSCF node sends back its address, which later will be used by the P-CSCF node for subsequent SIP signalling towards the core network. Thereafter the P-CSCF node stores the user registration info associated with the IMPU and sends an acknowledgement to the UE that now is registered.

When the UE is done with the services and wants to disconnect from the IMS, deregistration may be initiated by the UE.

### SUMMARY

It is in view of the above considerations and others that the various embodiments of the present invention have been made. The inventors have realized that today deregistration is initiated only from UEs. The inventors also recognized that it is possible to initiate a controlled deregistration from the P-CSCF node in the IMS. However, this would break a lot of existing IMS standard procedures and even if it would be allowed from a pure standard perspective a deregistration from for example the P-CSCF node would, from a HSS point of view, not appear any different then a deregistration from the UE, i.e. today there is no mechanism in the standard that shows the origin of an P-CSCF node initiated deregistration. Despite these facts the inventors decided to increase the functionality of the P-CSCF node such that it in a traceable way also supports additional network security features. Such features may for example be to block ill-intended or unwanted users from attacking the IMS system by deregistering users and add them into a firewall or a blacklist in the P-CSCF.

It is therefore a general object of the various embodiments of the present invention to facilitate deregistration that is initiated and performed by the P-CSCF node such that the origin of the deregistration initiation is traceable.

According to a first aspect, there is provided a method for deregistration of the UE from the IMS, said deregistration being initiated from and performed by the P-CSCF node. The method comprises monitoring at least one parameter associated with UE behaviour in the IMS and triggering the generation of a message in response to that the monitored parameter meets predefined criteria. The message is inserted in a SIP, Session Initiation Protocol, header message and sent to the S-CSCF node. The P-CSCF node then receives an acknowledgement from the S-CSCF node that the UE has been deregistered from the HSS and terminates the UE session with the IMS.

In preferred embodiments the generation of the message is triggered if the SIP signalling from the UE is over-flooding or if the UE exceeds a predetermined media plan bandwidth value. Preferably the message is inserted in a Call-Info SIP header and comprises at least one attribute reflecting the type of behaviour of the UE in the IMS.

According to other preferred embodiments of the present invention the attribute may trigger temporarily deregistering of the UE from the IMS during a predetermined period of time or permanently deregistering the UE from the IMS.

In yet another preferred embodiment the P-CSCF node collects data about UE's that have been deregistered from other P-CSCF nodes and prevents any of the previously deregistered UE's to register to the IMS either temporarily or permanently.

According to a second aspect, there is provided a P-CSCF node for performing deregistration of the UE from the IMS. The P-CSCF node comprises a processor and a memory for storing a computer program comprising computer program code which, when run in the processor, causes the P-CSCF node to monitor at least one parameter associated with UE behaviour in the IMS and trigger the generation of a message in response to that the monitored parameter meets predefined criteria. The message is inserted in a SIP header message and sent to the S-CSCF node. The P-CSCF then receives an acknowledgement from the S-CSCF node that the UE has been deregistered from the HSS and the UE session with the IMS will be terminated.

According preferred embodiments of the present invention the memory and the computer program code are configured, with the processor, to further cause the node to trigger the generation of the message if the SIP signalling from the UE is over-flooding or if the UE exceeds a predetermined media plan bandwidth value.

In yet other embodiments the P-CSCF node is caused to insert the message in a Call-Info SIP header.

In further embodiments the P-CSCF node is caused to insert a message comprising at least one attribute reflecting the type of behaviour of the UE in the IMS, said attribute may trigger temporarily deregistering of the UE from the IMS during a predetermined period of time or permanently deregistering the UE from the IMS.

In other embodiments the P-CSCF node is caused to collect data about UE's that have been deregistered from other P-CSCF nodes and prevent any of the previously deregistered UE's to register to the IMS.

According to a third aspect, there is provided a computer program. The computer program comprises computer program code which, when run in the processor of the P-CSCF, causes the P-CSCF to perform the method according the first aspect described above.

According to a fourth aspect, there is provided a computer program product. The computer program product may comprise computer program according to the third aspect and a computer readable means on which the computer program is stored.

Various aspects and embodiments of the present invention provide for facilitated deregistration of UEs such that the UE may be barred or quarantined from IMS. Depending on how serious the type of behaviour of the UE is, i.e. to what extent the present user rules are violated the harder the consequence is for the UE. A small misbehaviour may lead to termination (deregistration) of the present session, but nothing else. A serious misbehaviour may lead to that the UE is banned “for life”.

### BRIEF DESCRIPTION OF THE DRAWINGS

These and other aspects, features and advantages of the invention will be apparent and elucidated from the following description of embodiments of the present invention, reference being made to the accompanying drawings, in which:

FIG. 1 is a schematic diagram illustrating of an IP Multimedia subsystem;

FIG. 2 illustrates a schematic diagram of an example P-CSCF node according to an embodiment of the present invention;

FIG. 3 is a flow chart illustrating a method performed by the P-CSCF node according to an embodiment of the invention; and

FIG. 5 schematically shows one example of a computer program product comprising computer readable means.

### DETAILED DESCRIPTION

The invention will now be described more fully hereinafter with reference to the accompanying drawings, in which certain embodiments of the invention are shown. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like numbers refer to like elements throughout the description.

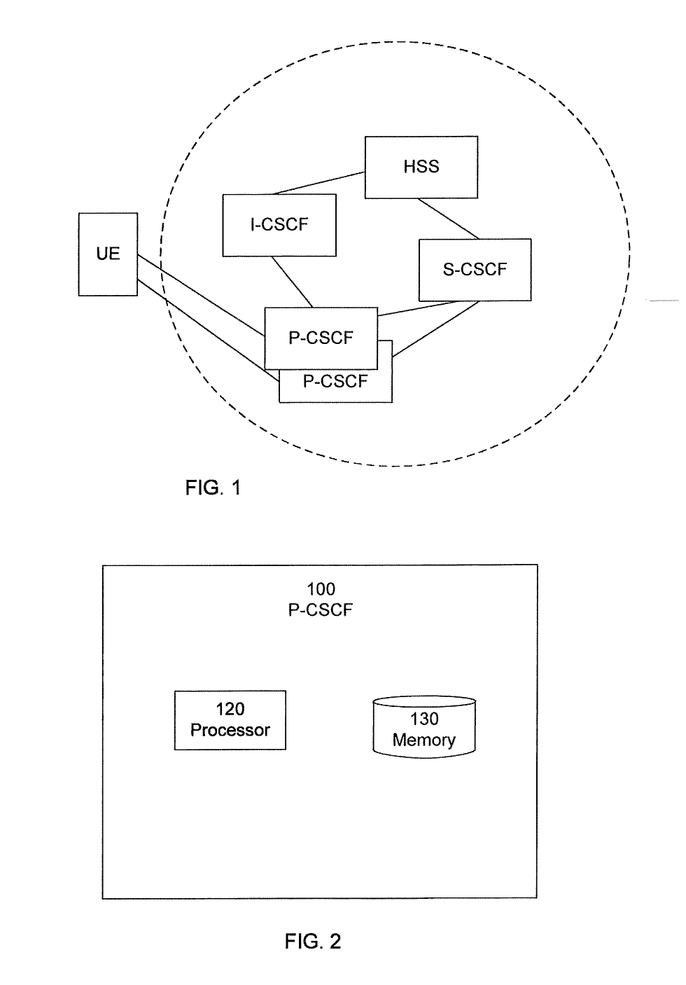

FIG. 1 illustrates a schematic IMS architecture, or system, for the mere purpose of putting exemplary embodiments of the present invention into a proper context. It should be noted that the IMS core network depicted in FIG. 1 only shows the functions and parts needed for understanding the present invention and is not to be seen as a complete description of the IMS.

Thus, the parts depicted in FIG. 1 are a UE that is associated with a subscriber or a user that wants to connect to the IMS. As is understood by a person skilled in the art there are in reality many UEs that are connected to the IMS simultaneously. The simplified IMS core network in FIG. 1 further shows several Call Session Control Function nodes, such as P-CSCF, S-CSCF and I-CSCF that are used to process SIP signalling packets in IMS. FIG. 1 furthermore shows a HSS, which is a master user database that supports the IMS network entities in handling calls. It contains subscription related information such as subscriber profiles and performs authentication and authorization of the user (UE). The HSS may furthermore provide location and IP information about the user.

The P-CSCF node may be a SIP proxy that usually is the first point of contact for the UE (user) when it wants to access the IMS. Among its tasks the P-CSCF node provides subscriber authentication, prevents spoofing and replay attacks, protects the privacy of the subscriber and inspects the signalling of the UE to ensure proper use of the IMS. In almost all IMS core networks there are more than one P-CSCF node.

The S-CSCF node is the central node of the signalling plane. The S-CSCF may be a SIP server but performs session control too. The S-CSCF handles among other functions SIP registrations, provides routing services, enforces the policy of network operators and is the link between the P-CSCF node and the HSS. There may be multiple S-CSCF nodes in the network for load distribution and high available reasons.

The I-CSCF may be another SIP server that is located at the edge of an administrative domain. Its IP address is published in a DNS, Domain Server System. The I-CSCF node queries the HSS to retrieve the address of the S-CSCF node and assign it to the user performing SIP registration.

As mentioned above there are several SIP servers or proxies having different functions. In the present invention these servers or proxies are generally described as for example the P-CSCF node. It should however be understood that even if these servers or proxies are depicted as different nodes, they should rather be seen as different functions, i.e. it is possible to integrate some or all of the servers or proxies in one or several nodes. Thus, in the context of the present invention P-CSCF node for example means a node which comprises the P-CSCF function.

The UE which may e.g. be embodied as a mobile telephone (sometimes also referred to as mobile phone, cell phone, cellular telephone, smart phone and the like), mobile communication device, tablet computer, laptop computer etc. The key of the present embodiment is the P-CSCF node initiated and traceable deregistration of the UE from the IMS. In context of the present invention the interpretation of “deregistration of the UE” is very broad, i.e. it may include deregistration of a subscriber or of the subscribers IMPU, IMS Public User Identity, or IMPI, IMS Private User Identity. Thus, in a technical sense it is not always the identity of the UE itself that it deregistered, but the identity of the subscriber. However, if the identity of the subscriber is deregistered this of course also directly disconnects (deregisters) the UE associated with the subscriber or user in question from the IMS.

FIG. 2 is a schematic diagram illustrating some modules of an embodiment of the P-CSCF node 100. The P-CSCF node 100 is suitable for inspecting the signalling and ensuring that the UE does not misbehave, for example change normal signalling routes or disobey the routing policies of the home network. The P-CSCF node 100 comprises a processor 120 and memory 130. The processor 120 may be provided using any suitable central processing unit (CPU), microcontroller, digital signal processor (DSP), etc., capable of executing computer program comprising computer program code, the computer program being stored in the memory 130. The memory 130 may be any combination of random access memory (RAM) and read only memory (ROM). The memory may also comprise persistent storage, which, for example, can be any single one or combination of magnetic memory, optical memory, or solid state memory or even remotely mounted memory.

Even if the examples below often only describe what happens in one P-CSCF node it should be understood that the IMS usually comprises several P-CSCF nodes and that the same method as described below may be performed by all or some P-CSCF nodes.

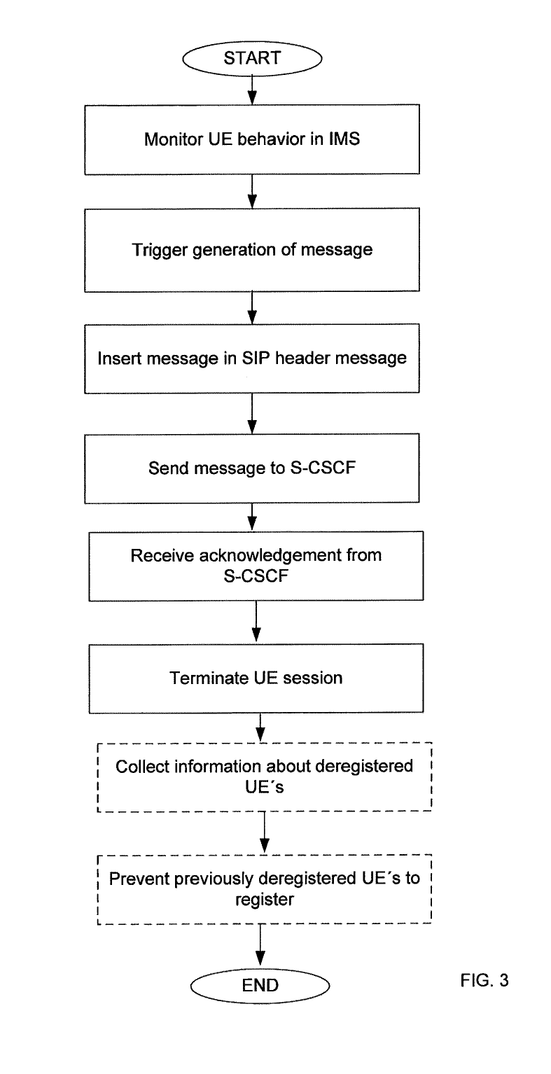

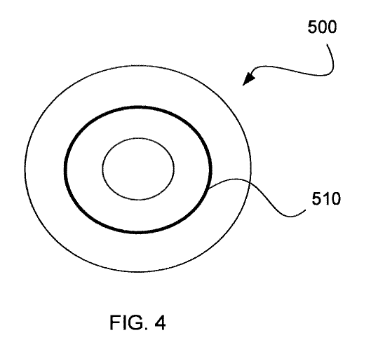

The memory 130 stores a computer program comprising computer program code which, when run in the processor 120, causes the P-CSCF node 100 to perform the method according to the present invention, which will be further described in conjunction with FIG. 3 below.

Now turning to FIG. 3, the method for deregistering the UE from the IMS will be described in more detail. Deregistration of the UE is according to the present invention initiated from the P-CSCF node. The P-CSCF will provide enhanced information towards the IMS core network to enable barring or quarantining of the UE or as mentioned above the subscriber IMPI (or subscriber IMPU, for the associated IMPI).

According to the method depicted in FIG. 3 the P-CSCF node continuously monitors the behaviour of the UE or subscriber that is connected to the IMS. The type of behaviour that is monitored may be if the SIP signalling from the UE is over-flooding or if the UE exceeds a predetermined media plan bandwidth value. In context of the present invention the type of behaviour that is monitored is behaviour that might be considered as harmful for the IMS, that affects other users of the IMS in a negative way or that breaks policies or rules of the operator etc.

If the P-CSCF node registers or detects such unwanted behaviour it will trigger the generation of a message intended to inform the S-CSCF and the HSS about such behaviour. The message is inserted in a SIP header message. There are several ways to do this. One solution is to create a new SIP header in the de-REGISTER message or by using the Call-Info SIP header that is already present. The message may comprise a least one attribute that reflects the type of behaviour that the P-CSCF node has detected. Depending on the detected behaviour the type of deregistration that is performed by the P-CSCF node may vary from temporarily deregistering (quarantining) the UE from the IMS during a predetermined time period, to permanently deregistering (barring) the UE from the IMS or blocking the UE from the IMS. It should be understood that the definition of temporarily deregistering the UE is that the UE is first deregistered and thereafter blocked during a predetermined time.

The message is then sent to the S-CSCF node which forwards it to the HSS. The P-CSCF node will then receive an acknowledgement from the S-CSCF node that the UE has been deregistered from the HSS. The ongoing UE session between the UE and the IMS can also be terminated. This last described step may also be done immediately after the P-CSCF node detects unwanted UE behaviour.

In a preferred embodiment of the present invention the method for deregistering the UE further comprises collecting data about UE's that have been deregistered from other P-CSCF nodes and sending such data to all P-CSCF nodes that are connected to the IMS in order to create a “blacklist” of UEs that are prevented to register to the IMS. This information might of course also be sent and shared with other IMSs, i.e. in another operator domain or another IMS core network belong to another operator.

When the P-CSCF node decides to bar or quarantine the UE or one IMPI (or an IMPU for the associated IMPI) which has registered contacts on this specific P-CSCF node or deregister the same IMPU with associated contact (address or address port) that is registered via another P-CSCF node from the whole IMS it shall send a de-REGISTER message with extra information in the Call-Info (RFC3261) SIP header, or alternatively provide this information in a new SIP header. This message is a request to the S-CSCF node to initiate additional actions against the registered user. Upon receipt of the de-REGISTER message, the S-CSCF node takes appropriate actions based on the indications or attributes included in the Call-Info header message, to bar or quarantine the UE (IMPI or the IMPU) from the IMS via interaction with the HSS.

For all P-CSCF nodes that are subscribing to a Reg Event package, also for P-CSCF nodes in other access networks, the S-CSCF node will send out NOTIFY messages that correspond to the subscription. These P-CSCF nodes may then upon receipt of the Reg Event NOTIFY message take appropriate action to add the UE (IMPU or IMPI) to a blacklist or quarantine status.

Thus having described the method according to the present invention with reference to FIG. 3 in a comprehensive way more detailed examples of the signalling within the IMS will be given below.

### Example

This is a detailed example of P-CSCF node initiated deregistration. The example is based on the following assumptions.

1) User Alice (IMPU) sip:alice@example.com has registered herself at the P-CSCF1 node via UE1 with Contact address1: 10.10.121.7:8004 in one registration flow.

2) User Alice (IMPU) sip:alice@example.com has also registered herself at the P-CSCF2 node via UE 1 with Contact address2:10.10.121.7:8007 in another registration flow.

3) Both the P-CSCF1 node and P-CSCF2 node have subscribed for the Reg Event package from the S-CSCF node for the user Alice.

If now user Alice violates any rules or polices or sometimes also due to administrative needs, the P-CSCF1 node may choose to bar or quarantine the IMPI (or only the IMPU for the associated IMPI), or to deregister the registered IMPU/Contact from the IMS core by initiating a de-REGISTER SIP message towards the S-CSCF node. The S-CSCF node does this for the existing registration dialog by using the extra space in the Call-Info SIP header with the URI, Uniform Resource Identifier set to the domain name of the P-CSCF1 node. In the Call-Info SIP header the purpose parameter (attribute) is set to “bar” if the P-CSCF node wants to bar the IMPI or IMPU/IMPI in the associated registration from the IMS. The target parameter (attribute) is set to impu, if it wants to bar IMPU for the associated IMPI and to impi, if it wants to bar the IMPI.

The purpose parameter may also be set to “quarantine” if the P-CSCF node wants to block the IMPI or IMPU in the associated registration temporarily from the IMS. In this case the target parameter is set to impu, if it wants to quarantine the IMPU for the associated IMPI in the current registration or to impi, if it wants to quarantine the IMPI in the current registration. Furthermore, the target parameter may also be set to impu_address if the P-CSCF node wants to quarantine the same IMPUs (registered either from P-CSCF1 or from P-CSCF2) registered on the same Contact-Address which the user currently is registered with or the target parameter may be is set to impu_addressport, if the P-CSCF node wants to quarantine the same IMPUs (registered either from P-CSCF1 or from P-CSCF2) registered on the same Contact-Address and Port which the user currently is registered with. A time parameter is set to control the time period during which the P-CSCF node wants to put the UE into quarantine. The time may be set in seconds.

As a third alternative the purpose parameter may be set to “dereg” if the P-CSCF node wants to deregister the registered IMPU and Contact binding in the current registration from the IMS (the same IMPU registered on the same address or address port, either from the current P-CSCF node or from other P-CSCF nodes). If the P-CSCF node wants to deregister the registered IMPU and associated Contact-Address binding or if the P-CSCF node wants to deregister the registered IMPU and associated Contact-Address-Port binding the target parameter may as mentioned above be set to either impu_address or impu_addressport respectively.

Upon receipt of the de-registration request from any of the P-CSCF nodes the S-CSCF node identifies the additional actions it need to perform by reading parameters or attributes in the Call-Info header. In case the purpose parameter is “bar” or “quarantine” and the target parameter is impu or impi the S-CSCF node sends a SAR, Service Assignment Request, as usual to deregister the IMPU and the associated contact from the HSS but with a new AVP, Attribute Value Pair, with the content taken from the Call-Info SIP header of the de-REGISTER message. The content of the other parts of the SAR follows the 3GPP standard.

Depending on how the purpose parameter has been set the S-CSCF node shall search the active registration data and deregister the registration flows with the same IMPU <sip:alice@example.com> on the contacted address 10.10.121.7:8004 or on the contacted address and port 10.10.121.7:8004 or send the SAR as usual to deregister the IMPU and the associate contact from the HSS. The HSS acts according to what is specified in the SAR or follows the normal behaviour to finish the SAR handling and responds with SAA, Software Security Assurance for the deregistration.

The S-CSCF node will terminate all registrations (including the multiple registration flows) for the IMPU and releases all on-going sessions related to this IMPU, if the IMPU is barred or quarantined or for each IMPU associated with the IMPI, if the IMPI is barred or quarantined and releases all on-going sessions related to each IMPU. The S-CSCF node furthermore terminates all matched registrations of the same IMPU and on the associated contact address or contact address port (registered from any P-CSCF node) in case the purpose parameter is “quarantine” or “dereg” and the target parameter is impu_address or impu_addressport and releases all on-going sessions related to these registrations. After this is done the S-CSCF node will respond to the de-REGISTER request from the P-CSCF node by sending an OK. Depending on local policies and according to the actions that the P-CSCF1 node wants to perform, the P-CSCF1 node may add the IMPI or IMPU/IMPI into the blacklist or into quarantine for a specific period of time and block the user from sending any requests towards IMS core network. Alternatively the P-CSCF1 node may add the IMPU/Contact (address or address: port) pair or just Contact (address or address:port) into quarantine to block the user from sending any request towards IMS core network from the UE specific IP address or IP address port.

For the P-CSCF2 node which has subscribed towards the Reg Event Package, the S-CSCF node may follow the procedures according to the 3GPP TS 24.229 Standard and create a NOTIFY message including the Reg Event Package to inform the P-CSCF2 node of the registration status for the user Alice. After the above procedures, the P-CSCF1 and P-CSCF2 nodes have added the IMPI, IMPU for associated IMPI, IMPU/Contact (address or address: port) pair into the blacklist or quarantine. Any SIP requests using the IMPU from the associated UE will be blocked at the border of the network in the barring and quarantine cases. Alternatively, all the associated IMPU/Contacts (address or address: port) are deregistered from the whole IMS system when requested from one single P-CSCF node if the purpose parameter was set to “dereg” in the Call-Info SIP header.

Thus a detailed example of the present invention has been described. However, it should be noted that there are many other ways to use SIP header messages in order to initiate deregistration form the P-CSCF node as is readily appreciated by a person skilled in the art. Thus the present invention is not limited to this example, which is a mere example of a practical implementation of the invention, but only to the appended claims.

No turning to FIG. 4 which schematically shows one example of a computer program product 500 comprising computer readable means 510. On this computer readable means 510, a computer program can be stored, which computer program, when run on the processor 120 in the P-CSCF node 100, can cause the P-CSCF node to execute the method according to various embodiments described in the present disclosure. In this illustrative example, the computer program product is an optical disc, such as a CD (compact disc), a DVD (digital versatile disc) or a blue-ray. However, in preferred embodiments the computer-readable means can also be solid state memory, such as flash memory or a software package (also sometimes referred to as software application, application or app) distributed over a network, such as the Internet.

There are many advantages with the present invention where deregistration of unwanted users or UEs is initiated from the P-CSCF node. This allows for the P-CSCF node to initiate deregistration and blocking of unwanted users from the whole IMS instead of only locally in the P-CSCF node itself. The invention supports both automatic detection of an abusing UE in the P-CSCF node with associated blocking (barring or quarantine of the UE) of the UE in the rest of the IMS. The present invention also enables for operator initiated administrative deregistration of the UE in the P-CSCF node (barring or quarantine of the UE) as an alternative when automatic detection of an abusing UE is not feasible.

Although the present invention has been described above with reference to specific embodiments, it is not intended to be limited to the specific form set forth herein. Rather, the invention is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A method for deregistration of a UE, User Equipment, from a IMS, Internet Protocol Multimedia Subsystem, said deregistration being initiated from and performed by a P-CSCF, Proxy-Call Session Control Function, node comprising;
monitoring at least one parameter associated with UE behaviour in the IMS,
triggering the generation of a message in response to that the monitored parameter meets a predefined criteria,
inserting the message in a SIP, Session Initiation Protocol, header message,
sending the SIP header message to a S-CSCF, Serving-Call Session Control Function, node,
receiving an acknowledgement from the S-CSCF node that the UE has been deregistered from the HSS, and
terminating the UE session with the IMS.

2. The method according to claim 1, wherein triggering the generation of the message is performed based on the SIP signalling from the UE over-flooding.

3. The method according to claim 1, wherein triggering the generation of the message is performed based on the UE exceeding a predetermined media plan bandwidth value.

4. The method according to claim 1, wherein the message is inserted in a Call-Info SIP header.

5. The method according to claim 1, wherein said message comprises at least one attribute reflecting the type of behaviour of the UE in the IMS.

6. The method according to claim 1, wherein the message comprises an attribute for deregistering the UE temporarily from the IMS during a predetermined period of time.

7. The method according to claim 1, wherein the message comprises an attribute for permanently deregistering the UE from the IMS.

8. The method according to claim 1, further comprising:
collecting data about UE's that have been deregistered from other P-CSCF nodes and,
preventing any of the previously deregistered UE's to register to the IMS.

9. A P-CSCF, Proxy-Call Session Control Function, node for performing deregistration of a UE, User Equipment, from a IMS, Internet Protocol Multimedia Subsystem, said node comprises;
a processor; and
a memory storing a computer program comprising computer program code which, when run in the processor, causes the P-CSCF node to:
monitor at least one parameter associated with UE behaviour in the IMS,
trigger the generation of a message in response to that the monitored parameter meets a predefined criteria,
insert the message in a SIP, Session Initiation Protocol, header message,
send the SIP header message to a S-CSCF, Serving-Call Session Control Function, node,
receive an acknowledgement from the S-CSCF node that the UE has been deregistered from the HSS, and
terminate the UE session with the IMS.

10. The P-CSCF node according to claim 9, wherein the memory and the computer program code are configured to, with the processor, further cause the node to trigger the generation of the message based on the SIP signalling from the UE over-flooding.

11. The P-CSCF node according to claim 9, wherein the memory and the computer program code are configured to, with the processor, further cause the node to trigger the generation of the message based on the UE exceeding a predetermined media plan bandwidth value.

12. The P-CSCF node according to claim 9, wherein the memory and the computer program code are configured to, with the processor, further cause the node to insert the message in a Call-Info SIP header.

13. The P-CSCF node according to claim 9, wherein the memory and the computer program code are configured to, with the processor, further cause the node to insert a message comprising at least one attribute reflecting the type of behaviour of the UE in the IMS.

14. The P-CSCF node according to claim 9, wherein the memory and the computer program code are configured to with the processor, further cause the node to insert a message comprising an attribute for deregistering the UE temporarily from the IMS during a predetermined period of time.

15. The P-CSCF node according to claim 9, wherein the memory and the computer program code are configured to, with the processor, further cause the node to insert a message comprising an attribute for permanently deregistering the UE from the IMS.

16. The P-CSCF node according to claim 9, wherein the memory and the computer program code are configured to, with the processor, further cause the node to collect data about UE's that have been deregistered from other P-CSCF nodes and prevent any of the previously deregistered UE's to register to the IMS.

17. A computer program product comprising computer program code on a non-transitory computer readable medium, the computer program code, when run in a processor of the P-CSCF node, causes the P-CSCF node to perform the method according to claim 1.

18. (canceled)
